(19) United States
(12) Patent Application Publication
(10) Pub. No.: US 2006/0251311 A1
(43) Pub. Date: Nov. 9, 2006

(54) Method and apparatus for analyzing biological tissue images

(75) Inventors: Nicola Dioguardi, Rozzano(Milano) (IT); Fabio Grizzi, Rozzano(Milano) (IT); Carlo Russo, Rozzano(Milano) (IT); Barbara Franceschini, Rozzano(Milano) (IT); Piercarlo Muzzio, Padova (IT)

Correspondence Address: MERCHANT & GOULD PC, P.O. BOX 2903, MINNEAPOLIS, MN, 55402-0903, US

(73) Assignee: HUMANITAS MIRASOLE S.p.A., Rozzano(milano) (IT)

(21) Appl. No.: 10/560,649

(22) PCT Filed: Jul. 22, 2003
(86) PCT No.: PCT/IB03/03332

§ 371 Date: Dec. 13, 2005

(51) Int. Cl. G06K 9/00

(52) U.S. Cl. 382/131

(57) ABSTRACT

The present invention relates to a method and an apparatus for processing images of biological tissues, in particular of human or animal origin. The metric quantification of a biological body part or tissue or of an abnormal material spot or aggregate contained therein is also performed by means of the invention method. The method according to the invention is applied in particular to the Computed Axial Tomography technique. In particular, the present invention relates to a method for processing images acquired by a CAT scan technique, comprising a stage of homogeneity map generation (HOMO-GEN) which comprises the following steps: 1a) dividing the image into boxes of different size iteratively, firstly in four quadrants, then proceeding by linear or exponential steps till a predefined size; 2a) calculating for each quadrant at each division scale the relative dispersion (RD) obtained as the Standard Deviation divided by the mean value of the pixels, in order to associate to each quadrant a set of values of RD; 3a) generating a homogeneity map as a grey scale image, each point's brightness being given by the mean of the set of values of RD for each quadrant, wherein the image's regions having higher brightness correspond to homogeneous regions.

### FIELD OF THE INVENTION

The present invention relates to a method and an apparatus for processing images of biological tissues, in particular of human or animal origin. The metric quantification of a biological body part or tissue or of an abnormal material spot or aggregate contained therein is also performed by means of the invention method.

The method according to the invention is applied in particular to the Computed Axial Tomography technique.

### BACKGROUND ART

With the term “abnormal material spot or aggregate” it is intended a material spot or aggregate morphologically connected with a pathological condition or a condition which gives rise to a pre- or post-pathological situation. Examples of abnormal material spot or aggregate may be tumors, atherosclerotic plaques, edemas, hematomes, acute or chronic inflammatory lesions, scars and collagen diseases.

When the diagnosis of a pathology requires the observation of a body part or organ, such observation can be direct or through indirect means, such as radiography, Computerised Axial Tomography (CAT), ecography analysis and the like. An image, i.e. a digital image of the observed body part or organ can be acquired and analysed by means of the computer.

Computer Axial Tomography (also known as CAT or CT scan) is a non-invasive diagnostic test that combines the use of X-rays with computer technology. The CAT scanner consists of a ring-shaped body wherein a patient's bed is caused to pass through slowly. Inside the ring-shaped boby there are located X-ray tubes and a bank of detectors which are positioned diametrically opposite to the X-ray tube. This latter and the detectors rotates 360° synchronously along the ring and thus around the patient's body. Many scans are taken for each body's section, so that a 2D-image of the section is created. As the body moves through the ring a complete scanning of the body—or of a selected body part—along the Z axis is taken. By the combination of the several sections' images, a 3D-reconstruction of the analysed body part is made by the computer by means of complex algorithms.

CAT scans are often used to detect and visualize soft tissue abnormalities, particularly in brain, chest, abdomen and pelvis. CAT images include a much higher level of details than conventional X-ray technique. In fact, while X-ray radiography captures from 20 to 30 shades of grey, with CAT it is possible to reach up to 200 shades of grey.

In many images taken with a CAT scan different objects can be detected in virtue of their colour or brightness uniformity. However, several cases are found, especially in the case of blurred images, wherein more or less indefinite contours render the object's delimitation quite difficult. In these cases, when the doctor observes the radiography or CAT image, he is just able to recognise areas or zones having similar homogeneity.

It is clear that any attempt to make a quantitative analysis of these objects can not be achieved without making dramatic and inadmissible calculation errors. On the other hand, metrical quantification of such objects would be pivotal for making an accurate diagnosis of the pathology. A typical example is the evaluation of the extension of atherosclerotic plaques or of tumors. In such a case, the known devices do not allow a correct quantification of the requested parameters, such as the volume, with the consequence that the outcome of the analysis may be incorrect or even misleading. There is therefore a need of improved apparatuses that allow a correct quantification of the morphometric parameters of any item for which such quantification is requested.

### SUMMARY OF THE INVENTION

The present invention addresses the above and other problems and solve them with a method and an apparatus as depicted in the attached claims.

Further characteristics and the advantages of the method and apparatus for analyizing irregularly shaped objects' images according to the present invention will become clear from the following description of a preferred embodiment thereof, given by way of non-limiting example, with reference to the appended drawings.

### BRIEF DESCRIPTION OF THE DRAWINGS

FIG. 1 is a schematic view of the apparatus according to the invention;

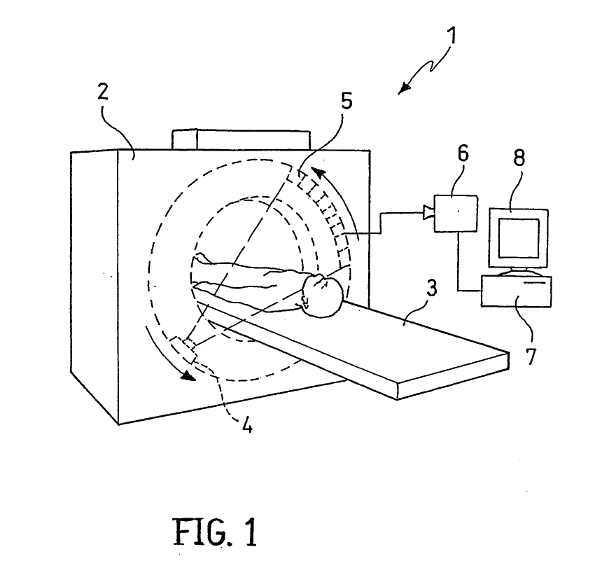

FIG. 2 is a flow chart illustrating the method of processing an image according to the invention.

### DETAILED DESCRIPTION OF THE INVENTION

The example that will be described hereinafter concerns a system 1 for acquiring and processing an image comprising a conventional CAT scan 2 having a motorised bed 3 capable of moving across the CAT scan.

The CAT scan 2 is provided with an X-ray tube 4 and a detector bank 5 positioned diametrically opposite to the X-ray tube. The X-ray tube 4 and the detector bank 5 are able to rotate synchronously around the said bed 3, wherein the patient lies, during the analysis.

Electronic image acquisition means 6 are operatively connected to the said detector bank 5. The electronic image acquisition means 6 are on their turn operatively connected to a processing system 7. The processing system 7 may be realized by means of a personal computer (PC) comprising a bus which interconnects a processing means, for example a central processing unit (CPU), to storing means, including, for example, a RAM working memory, a read-only memory (ROM)—which includes a basic program for starting the computer—, a magnetic hard disk, optionally a drive (DRV) for reading optical disks (CD-ROMs), optionally a drive for reading/writing floppy disks. Moreover, the processing system 7 optionally comprises a MODEM or other network means for controlling communication with a telematics network, a keyboard controller, a mouse controller and a video controller. A keyboard, a mouse and a monitor 8 are connected to the respective controllers. The electronic image acquisition means 6 are connected to the bus by means of an interface port (ITF). The motorised bed 3 is also connected to the bus by means of a control interface port (CITF) by which the movement of the stage along the Cartesian axis is governed.

A program (PRG), which is loaded into the working memory during the execution stage, and a respective data base are stored on the hard disk. Typically, the program (PRG) is distributed on one or more CD-ROMs for the installation on the hard disk.

Similar considerations apply if the processing system 7 has a different structure, for example, if it is constituted by a central unit to which various terminals are connected, or by a telematic computer network (such as Internet, Intranet, VPN), if it has other units (such as a printer), etc. Alternatively, the program is supplied on floppy disk, is pre-loaded onto the hard disk, or is stored on any other substrate which can be read by a computer, is sent to a user's computer by means of the telematics network, is broadcast by radio or, more generally, is supplied in any form which can be loaded directly into the working memory of the user's computer.

It is pointed out that some of the steps of the method of the invention can be performed by the computer system 7 by executing the program PRG.

The acquisition of the image from the CAT scan to the image acquisition means 6 is performed using standardised intensity values in DICOM format. DICOM (Digital Imaging and Communications in Medicine) is the internationally recognised industry standard for transferral of radiologic images between computers. The acquired image is converted to a 8-bit compatible PC format image using a window of DICOM intensity values which may change depending on the biological item to be analysed. For example, in the case of the lung, the following DICOM parameters are applied: Window=1100, Level=−400. This is due to the DICOM format that contains 12-bit image information from which it should be extracted a subset of 8-bit information. This is done by applying the values of window and level that specify what range of information is to be considered.

The selected image is then saved in the storing means of the processing system in a 256 value grey scale. The file format can be one of the image format normally used, such as jpeg or bitmap. Preferably, high quality jpeg format is used, in order to keep the requested image definition and save memory space.

The first stage of the image processing according to the invention is the stage of homogeneity map generation (HOMO-GEN stage).

The HOMO-GEN stage comprises the following steps:

1a) dividing the image into boxes of different size iteratively, firstly in four quadrants, then proceeding by linear or exponential steps till a predefined size;

2a) calculating for each quadrant at each division scale the relative dispersion (RD) obtained as the Standard Deviation divided by the mean value of the pixels, in order to associate to each quadrant a set of values of RD;

3a) generating a homogeneity map as a grey scale image, each point's brightness being given by the mean of the set of values of RD for each quadrant, and extending the mean values of RD in a range from 0 to 255, wherein the image's regions having higher brightness correspond to homogeneous regions;

4a) optionally, selecting the quadrants of the homogeneity map having a RD above a predefined threshold value, saving their position in the storing means of the processing system 7 and reconstructing an image made of the said selected quadrants.

In step 1a), the expression “proceeding by linear or exponential steps” means that the subdivisions can follow an exponential rule (i.e., starting from a side's length=1, the subdivisions will be ½, ¼, ⅛, 1/16 and so on) or a linear rule (such as, ½, ⅓, ¼, ⅕ and so on of the initial side's length).

The said “predefined size” in step 1a) ia a value above 1 pixel's side and that can be determined by the skilled man on a case by case basis.

In step 3a), the step of “extending the mean values of RD in a range from 0 to 255” is performed by multiplying the RD mean values associated to each pixel for an integer N above 1 and up to 255. Preferably N is 255. The RD mean values are usually comprised between 0 and 1, but they may also have values above 1. In this latter case the extended RD value would be above 255: since this is not a possible value, it is set to 255.

In step 3a), the said mean values can be weighted using different weights for each subdivision RD values, according to statistical methods well known to the expert in the field.

The generation of the homogeneity map depicted above allows one to identify the regions characterised by a certain homogeneity. As said before, this is essential in cases, like CAT images, wherein the digital image acquired by the instrument is often blurred and thus the identification of the different items is made difficult to a visual analysis.

The optional step 4a) is preferred in order to better delimit the homogeneous regions and thus allow their immediate identification and quantification.

According to a preferred embodiment of the invention, the method further comprises a step of generating a double image wherein the original CAT image and the corresponding homogeneity image are set side by side. This facilitates the interpretation of the homogeneity map by the doctor.

The next stage of the method according to the invention is the stage of homogeneity cleaning (HOMO-CLEAN stage).

This stage comprises the following steps:

1b) quantizing to 1 bit the homogeneity map generated according to the HOMO-GEN stage in order to create a black-and-white image;

2b) darkening, in the homogeneity map, the pixels homologues to the dark pixels in the said image quantized to 1 bit;

3b) generating an image resulting from the step 2b).

With the term “pixels homologues” in the homogeneity map and in the corresponding image quantized to 1 bit, they are intended those pixels that have the same Cartesian coordinates in the two images.

The HOMO-CLEAN stage allows to generate a clean image, wherein the background of the object to be observed is eliminated. However, such an object, for example an organ such as lung, may still evidence areas of different homogeneity which are possibly due to masses or spots present therein. These areas are usually the items to which the doctor is more interested to, such as tumors, hematomas or, in the case of vascular analysis, atherosclerotic plaques, and that must be quantified in order to calculate their area and, in the 3D-reconstruction, their volume. It has been noticed that such spots or masses have a greater homogeneity with respect to the surrounding tissues.

Therefore, the next stage of the method according to the invention is the stage of homogeneity identification (HOMO-ID stage). This stage comprises a step of quantizing to 1 bit the image generated according to the HOMO-CLEAN stage above. This allows to darken the pixels corresponding to image's areas of less homogeneity, while the brightness of the more homogeneous areas is emphasized.

The step of quantizing the image to 1 bit, both in the HOMO-CLEAN stage and in the HOMO-ID stage, is accomplished according to the following steps:

1c) considering a parameter for each pixel;

2c) comparing said pixel's parameter with a preset threshold value or threshold range for said parameter;

3c) selecting a cluster of active pixels and a cluster of inactive pixels on the base of said comparison.

Said pixel's parameter is preferably brightness intensity (grey scale). Said preset threshold value or range for said parameter will depend upon the kind of object that should be detected, which on its turn depends on the kind of biological tissue, etc. Selection of such threshold values or ranges can be made empirically by the skilled man, for the particular case, without excercize of any inventive skill. For example, if the object whose image has to be acquired is lung, the threshold range should be 0-128.

The above stages, i.e. the HOMO-GEN, HOMO-CLEAN and HOMO-ID stages, are sequentially performed on all the sections' images obtained through the scanning along the Z axis of the body part of the patient under examination. The so processed sections' images are then combined in order to reconstruct a 3D-image.

The next stage of method of the invention is thus the stage of 3D-reconstruction (3D-R stage). According to the invention procedure, the 3D-image is obtained by overlapping the 2D-images collected for each section of the examined body part according to operational routines which are well known to the expert in this field.

In some instances, due to even minor movements of the observed body part during the analysis performance, there can be some misalignement between one 2D-image and the subsequent 2D-image in the direction of scanning. In these particular cases, the method of the invention provides for an adjustement of the offset between the overlapped images.

In this case, the 3D-R stage comprises the following steps:

1d) overlapping each image with the subsequent image along the Z axis;

2d) minimizing the difference of brightness between overlapping pixels by shifting along the x axis and/or the y axis an image with respect to each other;

3d) repeating steps 1g) and 2g) for each pair of adjacent images.

Once the 3D-image has been reconstructed, the invention method proceeds with a stage of volume calculation (V-CLC stage). According to this stage the volume of the object under examination is determined.

The V-CLC stage comprises the following steps:

1e) calculating the area of each object in a first 2D-image corresponding to a first object's section;

2e) multiplying the area calculated according to step 1e) for the distance between the said first section's image and the subsequent section's image, taken in the Z direction of scanning, wherein an image of the same object is contained;

3e) reiterating steps 1e) and 2e) for each section's image in the order.

The overall volume of the objects in the examined tissue is determined as the sum of the single volumes calculated according to the above procedure.

The area calculation according to step 1e) is preferably made by counting the number of active pixels belonging to the same object and then multiplying for the area of the pixel.

The distance between each section's image and the subsequent one is a known parameter in the CAT scan technique.

The above volume was calculated by approximating the objects' volume to that of a substantially cylindrical solid. However, by approximating it to a frustum of cone, the volume being calculated as:
v=⅓d(A+a+\sqrt{A.a})

wherein d is the known distance between the two sections, A is the area of the first object's section and a is the area of the second object's section.

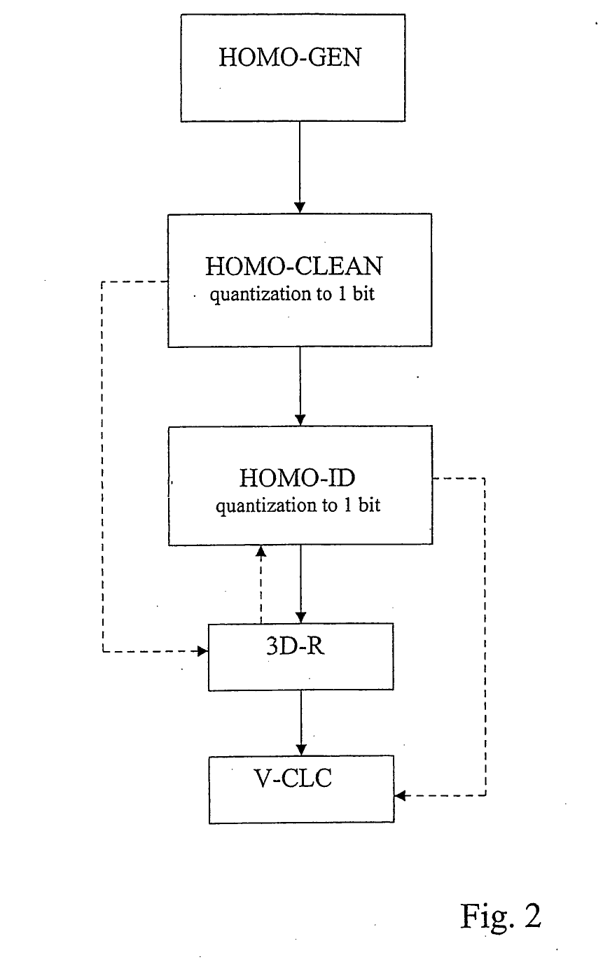

In an alternative embodiment of the invention, the V-CLC stage is performed just after the HOMO-CLEAN stage. The HOMO-ID stage is this performed on the 3D-image, i.e. on the several 2D-images of which the 3D-image is composed. The V-CLC stage is finally executed in order to give the object's volume. This variant of the method of the invention is depicted in FIG. 2, see broken lines.

It is also possible to highlight individual parts of the object in order to quantify sub-volumes by choosing different threshold in the HOMO-CLEAN stage. For example, in the lung it is possible to estimate the homogeneitu/heterogeneity volume of its aqueous components by choosing a brighter threshold in the HOMO-CLEAN stage.

As disclosed above, the method of the invention has the advantage of improving the visual analysis of a CAT scan by cleaning the image of the object under examination.

As a consequence of this feature, also the volume calculation is made more accurately, so that only minor errors are made in the diagnosis of the patient's pathology and in the evaluation of the pathology's progresses.

Naturally, only some specific embodiments of the method and apparatus for analyizing biological tissue specimens according to the present invention have been described and a person skilled in the art will be able to apply any modification necessary to adapt it to particular applications without, however, departing from the scope of protection of the present invention.

1. Method for processing images acquired by a CAT scan technique, comprising a stage of homogeneity map generation which comprises the following steps:
dividing the image into boxes of different size iteratively, firstly in four quadrants, then proceeding by linear or exponential steps till a predefined size;
calculating for each quadrant at each division scale the relative dispersion (RD) obtained as the Standard Deviation divided by the mean value of the pixels, in order to associate to each quadrant a set of values of RD;
generating a homogeneity map as a grey scale image, each point's brightness being given by the mean of the set of values of RD for each quadrant, and extending the mean values of RD in a range from 0 to 255, wherein the image's regions having higher brightness correspond to homogeneous regions.

2. Method according to claim 1, wherein the step of extending the mean values of RD in a range from 0 to 255 in the step of generating a homogeneity map is performed by multiplying the RD mean value associated to each pixel for an integer N above 1 and up to 255 and setting to 255 all the extended RD values that after the multiplication result in a number above 255.

3. Method according to claim 2, wherein N is 255.

4. Method according to claim 1, further comprising a step of:
selecting the quadrants of the homogeneity map having a RD above a predefined threshold value, saving their position in the storing means of the processing system and reconstructing an image made of the said selected quadrants.

5. Method according to claim 1, the method further comprising a step of generating a double image wherein the original CAT image and the corresponding homogeneity map are set side by side.

6. Method according to claim 1, further comprising a stage of homogeneity cleaning which comprises the following steps:
quantizing to 1 bit the homogeneity map generated according to the step of generating the homogeneity map to create a black-and-white image;
darkening, in the homogeneity map, the pixels homologues to the dark pixels in the said image quantized to 1 bit;
generating an image resulting from the step of darkening the pixels homologues.

7. Method according to claim 1, further comprising a stage of homogeneity identification (HOMO-ID) which comprises a step of quantizing to 1 bit the image generated according to the image generating the step of the homogeneity cleaning stage.

8. Method according to claim 6, wherein the said step of quantizing to 1 bit the homogeneity map or the image generated according to the image generating step of homogeneity cleaning stage, respectively, comprises the following steps:
considering a parameter for each pixel;
comparing said pixel's parameter with a preset threshold value or threshold range for said parameter;
selecting a cluster of active pixels and a cluster of inactive pixels on the base of said comparison.

9. Method according to claim 8, wherein said pixel's parameter is brightness intensity.

10. Method according to claim 1, further comprising a stage of 3D-reconstruction (3D-R) which comprises overlapping the 2D-images collected for each section along the Z axis of the examined object.

11. Method according to claim 10, which comprises the following steps:
overlapping each image with the subsequent image along the Z axis;
minimizing the difference of brightness between overlapping pixels by shifting along the x axis and/or the y axis an image with respect to each other;
repeating the overlapping steps and the brightness difference minimizing steps for each pair of adjacent images.

12. Method according to claim 1, further comprising a stage of volume calculation (V-CLC) which comprises the following steps:
calculating the area of each object in a first 2D-image corresponding to a first object's section;
multiplying the area calculated for the distance between the said first section's image and the subsequent section's image, taken in the Z direction of scanning, wherein an image of the same object is contained;
reiterating the steps of calculating the area of each object and multiplying the area calculated for the distance between the first section's image and the second section's image for each section's image in the order.

13. Method according to claim 12, wherein the overall volume of the objects in the examined tissue is determined as the sum of the single volumes.

14. Method according to claim 12, wherein the area calculation according to step 1e) is made by counting the number of active pixels belonging to the same object and then multiplying for the area of the pixel.

15. Method according to claim 12, the volume being calculated as:
v=⅓d(A+a+\sqrt{A.a})
wherein d is the known distance between the two sections, A is the area of the first object's section and a is the area of the second object's section.

16. A system for acquiring and processing digital images, comprising a CAT scan provided with a motorised bed and an X-ray tube and a detector bank positioned diametrically opposite to the X-ray tube, the X-ray tube and the detector bank being able to rotate synchronously around the said bed, the system further comprising electronic image acquisition means operatively connected to said CAT scan, a processing system operatively connected to said CAT scan and said image acquisition means, said processing system comprising a processing unit (CPU), storing means which include a RAM working memory and a hard disk, said processing system running a program (PRG) to perform a method according to claim 1.

17. A software program (PRG) to perform the method according to claim 1.

18. A computer readable support comprising a program (PRG) to perform the method according to claim 1.

19. (canceled)
